(19) United States
(12) Patent Application Publication
(10) Pub. No.: US 2008/0145496 A1
(43) Pub. Date: Jun. 19, 2008

(54) Composition to preserve food

(76) Inventor: Carl W. Cooper, Dallas, GA (US)

Correspondence Address: LITMAN LAW OFFICES, LTD., P.O. BOX 15035, CRYSTAL CITY STATION, ARLINGTON, VA, 22215, US

(21) Appl. No.: 11/000,127

(22) Filed: Dec. 1, 2004

(51) Int. Cl. C11C 3/00

(52) U.S. Cl. 426/322

(57) ABSTRACT

The composition to preserve food is a mixture of colloidal minerals, including colloidal silver, colloidal gold and colloidal titanium. The composition of ultramicroscopic particles is suspended in water, forming a solution. The solution is used for preserving perishable foods, such as fruits and vegetables, by submerging each food item in the liquid for various lengths of time. The solution may also be used for disinfecting tissues and various objects, as well as for other antimicrobial uses.

### BACKGROUND OF THE INVENTION

1. Field of the Invention

The present invention relates to methods for preserving food, and more particularly to a composition and method for preserving perishable foods using colloidal minerals.

2. Description of the Related Art

Silver has been used as a bactericide since ancient times. It has long been known to place silver coins in jars of milk or other drinking liquids and to consume food using silver containers and utensils. By electrolysis, silver can be released as colloidal silver and suspended in distilled water. Colloidal silver comprises ultramicroscopic particles of pure, elemental silver that are easily take in by the body. In appropriate amounts, colloidal silver has been used for a wide range of therapeutic uses, such as in anti-bacterial uses and for tissue healing and reconstruction. Similarly, it has long been known to use gold for bactericidal purposes, and more recently colloidal gold. However, to the best of the inventor's knowledge, it has not been previously suggested to combine a mixture of colloidal minerals for use as a food preservative or for other antimicrobial or therapeutic purposes in order to enhance the individual effectiveness of the colloidal minerals.

During the middle and latter part of the twentieth century, the use of silver, gold, and other metals for their bactericidal and antimicrobial properties declined due to the benefits of antibiotics. However, with the development of species of bacteria that are resistant to modern antibiotics, interest in colloidal minerals has been revived, as the heavy metals appear to operate by depriving microorganisms of the ability to metabolize oxygen, so that the microorganisms are unable to develop resistance to the colloidal minerals. Although silver has been useful in preserving food, as well as being used by itself for therapeutic purposes, a composition including colloidal silver is desired for preserving food by increasing shelf life of perishable fruit, vegetables and other foods, as well as for a number of other applications.

The following Japanese patents describe ionic solutions of various metals for the preservation of fruits, vegetables, and other foods, but none suggest the colloidal mineral mixture of the present invention: Japanese Patent No. 1-168,233, published Jul. 3, 1989 (palladium and one of a variety of other ions); Japanese Patent No. 1-304,871, published Dec. 8, 1989 (ammonium and an antibacterial metal ion); Japanese Patent No. 1-309,637 (heavy metallic ion, such as silver); Japanese Patent No. 2-167,060, published Jun. 27, 1990 (silver or zinc on a zeolite matrix); Japanese Patent No. 2-303,449, published Dec. 17, 1990 (carbon dioxide gas passed through absorbent material impregnated with silver ion); Japanese Patent No. 3-127,974, published May 31, 1991 (dipping in a solution containing one of various metal ions); Japanese Patent No. 4-293,448, published Oct. 19, 1992 (palladium salt and another metal salt); Japanese Patent No. 7-206,617, published Aug. 8, 1995 (copper and one of various other metals); and Japanese Patent No. 11-180,801, published Jul. 6, 1999 (silver with a complexing agent)

None of the above inventions and patents describes the present invention as claimed. Thus, a composition to preserve food solving the aforementioned problems is desired.

### SUMMARY OF THE INVENTION

The composition to preserve food is a mixture of colloidal minerals, including colloidal silver, colloidal gold and colloidal titanium. The composition of ultramicroscopic particles is suspended in water, forming a solution. The solution is used for preserving perishable foods, such as fruits and vegetables, by submerging each food item in the liquid for various lengths of time. The solution may also be used for disinfecting tissues and various objects, as well as for other antimicrobial uses.

The composition, when used to preserve food, is applied to the food item by dipping or submerging the item in the composition for a period of time, then storing the item in a dark, cool place. When used as a surface disinfectant or for any other antimicrobial use, the composition may be applied as a spray to control various diseases in homes, hospitals, gardens, fields, crops, plants, animals, fish and humans. The composition may be applied in any appropriate form, such as a mist, aerosol, vapor, fog, etc.

These and other features of the present invention will become readily apparent upon consideration of the following specification.

### DETAILED DESCRIPTION OF THE PREFERRED EMBODIMENTS

The present invention is a composition to preserve food formed from a combination of colloidal minerals, including colloidal silver, colloidal gold and colloidal titanium. The composition of ultramicroscopic particles is suspended in distilled water, forming a solution. The solution is best used for preserving perishable foods, such as fruits and vegetables, by submerging each food item in the water for various lengths of time. The solution may also be used for disinfecting tissues and various objects, as well as for other antimicrobial uses.

Electrolysis is one process by which the colloidal silver may be produced. Colloidal silver comprises ultramicroscopic particle of pure, elemental silver. In electrolysis, silver electrodes are placed at least one inch apart and above the bottom of a glass container containing distilled or reverse osmosis filtered water. Then an appropriate electric current is applied for a length of time sufficient to produce positive-charged silver particles. The process produces not just silver ions, but clusters of ionic silver particles ranging in size from about 0.0005 to 0.015 microns that are suspended in the distilled water, producing a colloidal suspension. The ultramicroscopic silver particles become dispersed throughout the liquid due to the repelling action of each charged particle. Colloidal gold and colloidal titanium are also made by electrolysis using the same or similar procedure described above. Other methods for producing colloidal silver, gold or titanium may include grinding or chemical methods.

The composition to preserve food comprises a combination of colloidal silver, colloidal gold and colloidal titanium. The three minerals are suspended in distilled water, forming a colloidal solution. The composition is a solution prepared from a mixture of 90% colloidal silver at 10 parts per million (ppm), 5% colloidal gold at 5 ppm, and 5% colloidal titanium at 5 ppm. Alternatively, silver, gold and titanium compounds not in the colloidal forms may equally be used in the present invention. When used to increase the shelf life of perishable fruits, vegetables, and other foodstuffs, various dilutions of the composition may be required, ranging from 10 ppm to 100 ppm.

Colloidal silver is known to be effective against about 650 strains of bacteria and viruses. Colloidal gold and colloidal titanium are believed to be effective against other strains of microbes that colloidal silver has not been shown to be effective against, so that the composition of the present invention enhances the effectiveness of colloidal silver solutions in preserving food and in other antimicrobial applications.

The composition may, however, take any combination of amounts to produce preserve food or serve a variety of other purposes. The composition may take any form such as a mist, aerosol, vapor, fog, etc. The composition, if used to preserve food, provides for dipping or submerging the food item in the composition for a period of time, then storing the food item in a dark cool place. The composition may be used as a foliar spray applied to growing crops, or as an aerosol, mist, or fog as a surface disinfectant and in other antimicrobial uses in homes, hospitals, gardens, fields, crops, plants, animals, fish and humans.

It is to be understood that the present invention is not limited to the embodiments described above, but encompasses any and all embodiments within the scope of the following claims.

1-4. (canceled)

5. An antimicrobial composition, consisting essentially of an aqueous solution of:
about 90% of 10 ppm colloidal silver;
about 5% of 5 ppm colloidal gold; and
about 5% of 5 ppm colloidal titanium.

6. The antimicrobial solution according to claim 5, wherein the solution is diluted to between about 10 ppm and 100 ppm for use as a food preservative.

7. A method of preserving a food item using the solution according to claim 6, comprising the steps of:
dipping the food item in the solution; and
storing the food item in a dark, cool location.

8. A method of preventing microbial contamination of a growing crop using the composition according to claim 5, comprising the step of spraying the crop with the composition.

9. A method of disinfecting a surface using the composition according to claim 5, comprising the step of spraying the surface with the composition.

10. A method of disinfecting a room using the composition according to claim 5, comprising the steps of atomizing the solution and introducing the atomized solution into air in the room.

11. (canceled)

12. A method of preserving a food item, comprising the steps of:
dipping the food item in an aqueous solution containing a mixture of colloidal silver, colloidal gold, and colloidal titanium; and
storing the food item in a cool, dark location.

13. The method according to claim 12, wherein the mixture consists essentially of 90% of 10 ppm colloidal silver, 5% of 5 ppm colloidal gold, and 5% of 5 ppm colloidal titanium, the mixture being diluted to between about 10 ppm and 100 ppm.

14. The method according to claim 12, wherein the mixture comprises 90% of 10 ppm colloidal silver, 5% of 5 ppm colloidal gold, and 5% of 5 ppm colloidal titanium.

15. The method according to claim 14, further comprising the step of diluting the mixture in distilled water to between about 10 ppm and 100 ppm.
